(19) United States
(12) Patent Application Publication
(10) Pub. No.: US 2009/0290051 A1
(43) Pub. Date: Nov. 26, 2009

(54) SOLID-STATE IMAGER AND METHOD OF MANUFACTURING THE SAME

(75) Inventor: Shigeru IWATA, Kanagawa (JP)

Correspondence Address: YOUNG & THOMPSON, 209 Madison Street, Suite 500, ALEXANDRIA, VA, 22314, US

(73) Assignee: NEC Electronics Corporation, Kanagawa (JP)

(21) Appl. No.: 12/470,078

(22) Filed: May 21, 2009

(30) Foreign Application Priority Data
May 26, 2008 (JP) 2008-136713

(51) Int. Cl. H04N 9/04; H04N 5/335

(52) U.S. Cl. 348/273; 348/294; 348/E05.091

(57) ABSTRACT

A solid-state imager including an imaging region, a color filter layer, and an electro-conductive component, wherein the imaging region has a plurality of light receiving elements positioned therein, the plurality of light receiving elements are formed to a substrate, while being arranged in a two-dimensional manner, the color filter layer is formed over and around the imaging region, the electro-conductive component exposes from the color filter layer, the electro-conductive component is positioned around the imaging region but without overlapping the imaging region.

This application is based on Japanese patent application No. 2008-136713, the content of which is incorporated hereinto by reference.

### BACKGROUND

1. Technical Field

The present invention relates to a solid-state imager having a plurality of light receiving elements, and a method of manufacturing the same.

2. Related Art

In solid-state imagers having a plurality of light receiving elements, color filter layers are composed of resins such as acryl resin and so forth. These resins tend to be electrically charged, and are likely to adsorb foreign matters. Electric charging is necessarily suppressed, since the adsorption of foreign matters may degrade functions of the solid-state imagers. Known techniques of suppressing adsorption of foreign matters onto the color filters layer include those described in Japanese Laid-Open Patent Publication Nos. 2006-210915, 2007-53153 and H2-105571.

The technique described in Japanese Laid-Open Patent Publication No. 2006-210915 is as follows. An image sensor having a light receiving portion is attached to the lower surface of a substrate having an opening formed therein. The light receiving portion is exposed out from the opening. A transparent component is then attached to the upper surface of the substrate. The transparent component has a projected portion which is inserted into the opening of the substrate.

The technique described in Japanese Laid-Open Patent Publication No. 2007-53153 relates to a configuration having microlenses provided on color filters, and further having a planarizing layer having a roughened surface provided on the microlenses. The planarizing layer is composed of an acryl resin, fluorine-containing acryl resin or the like

The technique described in Japanese Laid-Open Patent Publication No. H2-105571 relates to a configuration having a transparent electrode provided over the main surface of a semiconductor substrate having photodiodes provided thereon. The transparent electrode is applied with a certain level of potential.

In the technique described in Japanese Laid-Open Patent Publication No. 2006-210915, the transparent component is provided over the light receiving elements. Since the transparent component has a certain thickness, so that light incident on the light receiving elements is inevitably absorbed by the transparent component to a certain degree, before it reaches the light receiving elements.

In the technique described in Japanese Laid-Open Patent Publication No. 2007-53153, the planarizing layer provided to the surface is composed of a resin. The planarizing layer, therefore, tends to adsorb foreign matters when it is electrically charged, even if it is roughened on the surface thereof.

In the technique described in Japanese Laid-Open Patent Publication No. H2-105571, the transparent electrode is provided over the photodiodes. Since the transparent electrode absorbs light to a certain degree, the light incident on the photodiode is inevitably absorbed by the transparent electrode to a certain degree before it reaches the photodiode.

As has been described in the above, it has been difficult for the conventional techniques to suppress adsorption of foreign matters onto the surface of the solid-state imagers, while suppressing attenuation in the energy of light incident on the light receiving element.

### SUMMARY

According to the present invention, there is provided a solid-state imager, comprising:

a substrate;

an imaging region provided to the substrate, and including a plurality of light receiving elements;

a cover layer formed over and around the imaging region; and

an electro-conductive component exposed from the cover layer, and positioned around the imaging region but without overlapping the imaging region, when viewed in the direction normal to the substrate.

According to the present invention, the electro-conductive component is positioned around the imaging region, when viewed in the direction normal to the substrate. The electro-conductive component exposes out from the cover layer, and may thereby be suppressed from being electrically charged on the surface thereof. The cover layer may therefore be suppressed from adsorbing foreign matters on the surface thereof. The electro-conductive component, provided without overlapping the imaging region, may also suppress attenuation in the energy of light to be incident on the light receiving elements.

According to the present invention, there is provided also a method of manufacturing a solid-state imager, comprising:

forming a plurality of light receiving elements to a substrate;

forming an electro-conductive component over and around the plurality of light receiving elements, but without overlapping the plurality of light receiving elements; and

forming a cover layer over the plurality of light receiving element, so as to allow the electro-conductive component to expose out from the cover layer.

According to the present invention, the energy of light to be incident on the light receiving elements may be suppressed from decreasing, and the solid-state imager may be suppressed in adsorption of foreign matters on the surface thereof.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a plan view illustrating a solid-state imager according to a first embodiment;

FIG. 2 is a sectional view taken along line A-A′ in FIG. 1;

FIG. 3 is a sectional view explaining a method of manufacturing the solid-state imager illustrated in FIG. 1 and FIG. 2;

FIG. 4 is a sectional view explaining a step succeeding to the step illustrated in FIG. 3;

FIG. 5 is a sectional view illustrating a configuration of a solid-state imager according to a second embodiment;

FIG. 6 is a plan view illustrating a solid-state imager according to a third embodiment;

FIG. 7 is a sectional view taken along line B-B′ in FIG. 6;

FIG. 8 is a plan view illustrating a solid-state imager according to a fourth embodiment; and

FIG. 9 is a sectional view taken along line C-C′ in FIG. 8.

### DETAILED DESCRIPTION

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained referring to the attached drawings. Note that any similar constituents in all drawings will be given with similar reference numerals, and explanations therefor will not be repeated.

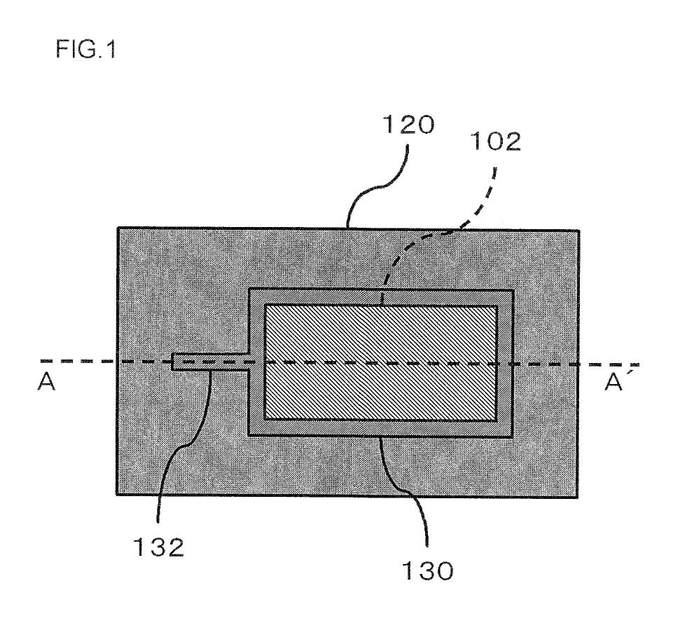

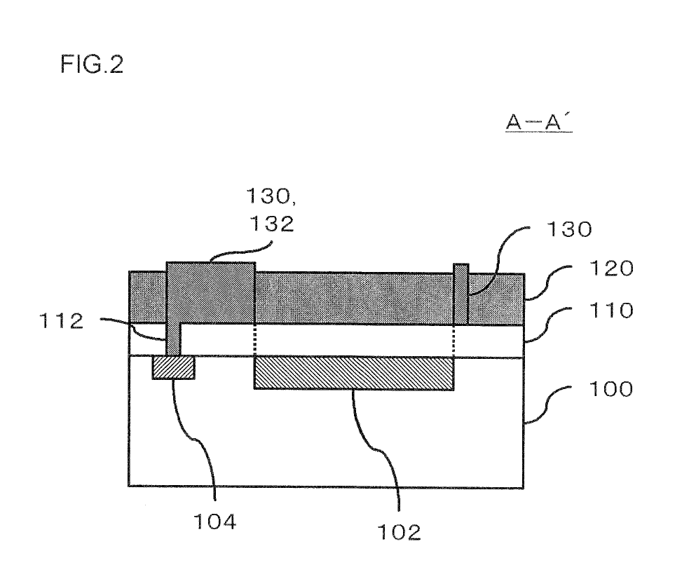

FIG. 1 is a plan view illustrating a solid-state imager according to a first embodiment, and FIG. 2 is a sectional view taken along line A-A′ in FIG. 1. As illustrated in FIG. 2, the solid-state imager has a substrate 100, an imaging region 102, a cover layer (color filter layer) 120, and an electro-conductive component 130. The substrate 100 is typically a semiconductor substrate such as a silicon substrate. The imaging region 102 has a plurality of light receiving elements arranged therein. The plurality of light receiving elements are formed to the substrate 100. The plurality of light receiving elements may be arranged in line, or in a two-dimensional manner. The color filter layer 120 is formed above and around the imaging region 102. The electro-conductive component 130 exposes out from the color filter layer 120. As illustrated in FIG. 1, the electro-conductive component 130 is positioned around the imaging region 102, but without overlapping the imaging region 102, when viewed in the direction normal to the substrate 100. The imaging region 102 has a polygonal geometry, such as rectangle.

In this embodiment, the electro-conductive component 130 surrounds a region above the imaging region 102, and the upper portion thereof projects out from the color filter layer 120. The color filter layer 120 and the electro-conductive component 130 are formed over the insulating layer 110. The insulating layer 110 is composed, for example, of a silicon oxide layer, and is formed over the substrate 100 including the imaging region 102.

For the case where the substrate 100 is composed of a semiconductor substrate, the substrate 100 has an impurity-diffused region 104 formed therein. The impurity-diffused region 104 has the same conductivity type as the substrate 100 has (n-type, for example), and is connected through a contact 112 formed in the insulating layer 110, to an electro-conductive pattern 132 positioned in the same layer as the electro-conductive component 130. As illustrated in FIG. 1 and FIG. 2, the electro-conductive pattern 132 is connected to the electro-conductive component 130, and is extended from the electro-conductive component 130 in the direction away from the imaging region 102. The width of the electro-conductive pattern 132 is, for example, nearly identical to that of the electro-conductive component 130.

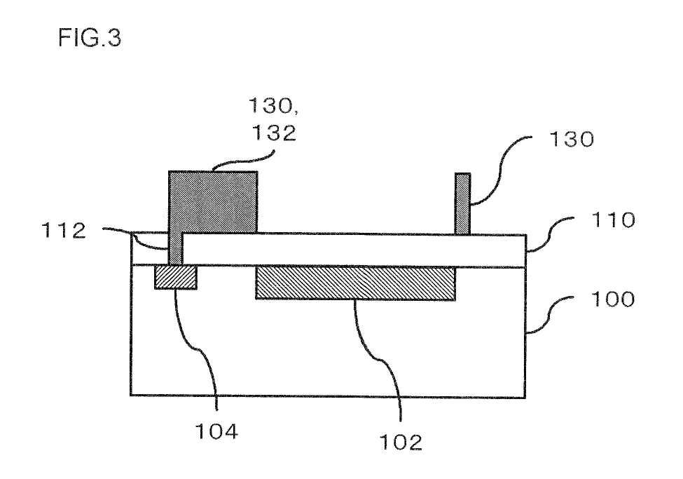

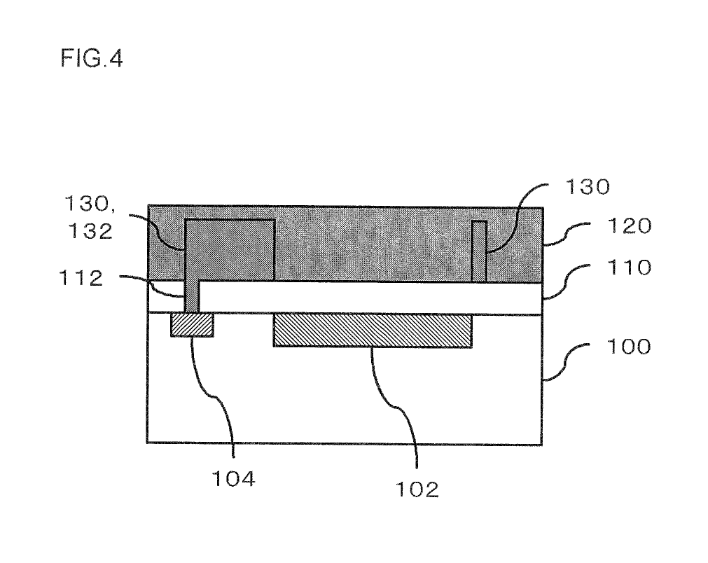

FIG. 3 and FIG. 4 are sectional views explaining a method of manufacturing the solid-state imager illustrated in FIG. 1 and FIG. 2. First, as illustrated in FIG. 3, a plurality of light receiving elements are formed in the imaging region 102 of the substrate 100. Also the impurity-diffused region 104 is formed in the substrate 100. The impurity-diffused region 104 may be formed in the process of forming the light receiving elements. The insulating layer 110 is then formed over the substrate 100. The insulating layer 110 is then selectively removed, to thereby form a contact hole fallen on the impurity-diffused region 104. Next, an electro-conductive film, such as an aluminum film or polysilicon film, is formed in the contact hole and over the insulating layer 110. The electro-conductive film is then selectively removed, to thereby form the contact 112, the electro-conductive component 130, and the electro-conductive pattern 132.

Next, as illustrated in FIG. 4, the color filter layer 120 is formed over the insulating layer 110, over the electro-conductive component 130, and over the electro-conductive pattern 132. The color filter layer 120 herein is formed also over the imaging region 102. The color filter layer 120 is typically composed of an acryl resin layer. Since the color filter layer 120 in this state is thicker than the electro-conductive component 130 and the electro-conductive pattern 132, so that the upper ends of the electro-conductive component 130 and the electro-conductive pattern 132 are covered with the color filter layer 120.

The surficial portion of the color filter layer 120 is then removed by anisotropic etching. By this process, the upper portions of the electro-conductive component 130 and the electro-conductive pattern 132 are exposed from the color filter layer 120 as illustrated in FIG. 2.

Next, the operations and effects of this embodiment will be explained. The electro-conductive component 130 exposes out from the color filter layer 120. Since static electricity may therefore be allowed to transmit from the color filter layer 120 to the electro-conductive component 130, so that the color filter layer 120, positioned above the imaging region 102, may be suppressed from adsorbing foreign matters. The electro-conductive component 130, as viewed in the direction normal to the substrate 100, is positioned around the imaging region 102 without overlapping the imaging region 102. Energy of light to be incident on the imaging region 102 may therefore be suppressed from decreasing. This effect may be more distinctive when the electro-conductive component 130 surrounds a region above the imaging region 102, as illustrated in FIG. 1.

The electro-conductive component 130 is connected through the electro-conductive pattern 132 and the contact 112 to the impurity-diffused region 104 in the substrate 100. By virtue of this configuration, static electricity transmitted to the electro-conductive component 130 may be discharged from the impurity-diffused region 104 to the substrate 100, rather than accumulated in the electro-conductive component 130. The color filter layer 120 may therefore be suppressed in adsorption of foreign matters in a more reliable manner.

The electro-conductive component 130 is projected out from the color filter layer 120. Foreign matters may, therefore, be more readily attracted by the electro-conductive component 130, but less likely to be attracted by the color filter layer 120. The foreign matters, if electrically charged at a very high potential, may induce corona discharge with respect to the electro-conductive component 130. Accordingly, the amount of electric charge on the foreign matters may be reduced, and thereby the foreign matters may be suppressed from being adsorbed by the color filter layer 120.

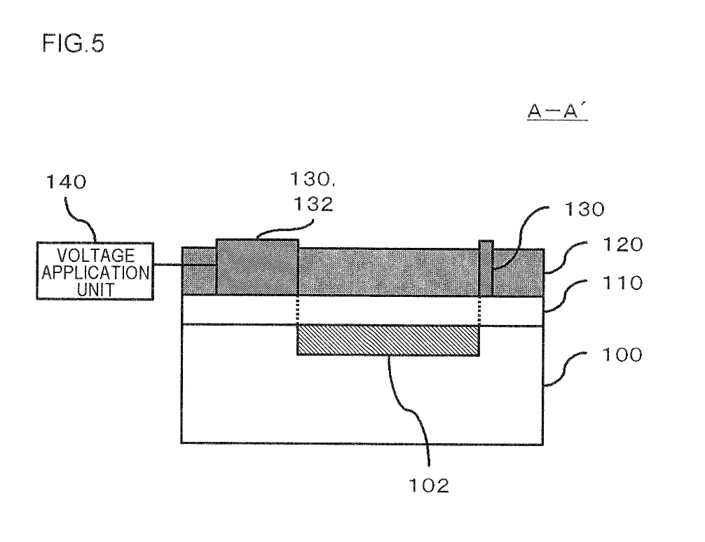

FIG. 5 is a sectional view illustrating a configuration of a solid-state imager according to a second embodiment. The drawing corresponds to FIG. 2 in the first embodiment. The solid-state imager of this embodiment is configured similarly to the solid-state imager according to the first embodiment, except that the impurity-diffused region 104 and the contact 112 are not provided, and that a voltage application unit 140 is provided.

The voltage application unit 140 is electrically connected to the electro-conductive pattern 132. The voltage application unit 140 applies a predetermined voltage through the electro-conductive pattern 132 to the electro-conductive component 130.

Also according to this embodiment, since static electricity may transmit from the color filter layer 120 to the electro-conductive component 130, so that the color filter layer 120 may be suppressed in adsorption of foreign matters. The electro-conductive component 130, as viewed in the direction normal to the substrate 100, does not overlap the imaging region 102. Energy of light to be incident on the imaging region 102 may therefore be suppressed from decreasing. Since the electro-conductive component 130 is projected out from the surface of the color filter layer 120, so that foreign matters may, therefore, be more readily attracted by the electro-conductive component 130, but less likely to be attracted by the color filter layer 120.

In addition, the electro-conductive component 130 may be applied with voltage while adjusting the polarity (negative, for example) which is reverse to the polarity (positive, for example) readily generated on the color filter layer 120. Thus-adjusted color filter layer 120 may exert repulsive force on foreign matters which have been charged to have the reverse polarity, and may therefore be suppressed from being accessed by the foreign matters.

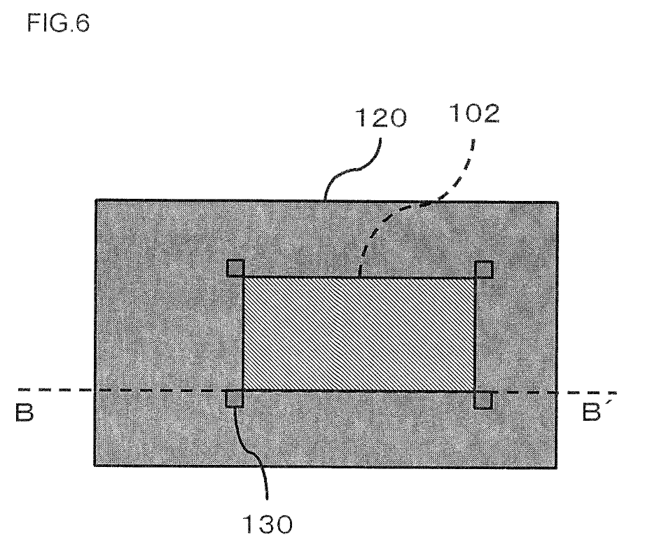

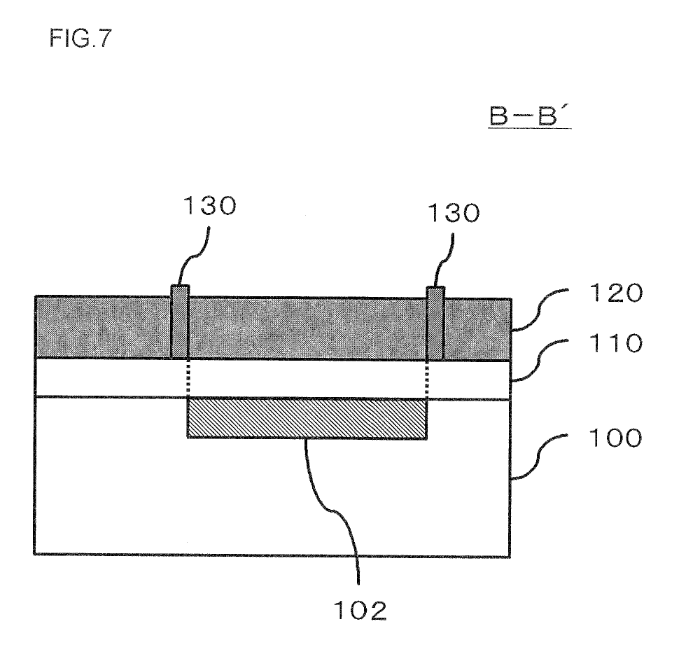

FIG. 6 is a plan view illustrating a solid-state imager according to a third embodiment, and FIG. 7 is a sectional view taken along line B-B′ in FIG. 6. The solid-state imager is configured similarly to the solid-state imager according to the first embodiment, except that the electro-conductive pattern 132, the contact 112, and the impurity-diffused region 104 adopted in the first embodiment are not formed, and that the electro-conductive component 130 is formed into a plurality of columnar components provided along the circumference of the imaging region 102 while being spaced from each other.

For the case where the imaging region 102 has a polygonal geometry, the electro-conductive components 130 are provided typically at positions in contact with the apex portions of the imaging region 102. For an exemplary case where the imaging region 102 has a rectangular geometry, the electro-conductive components 130 may be provided while being brought into contact with four corners of the imaging region 102.

Also in this embodiment, since static electricity may transmit from the color filter layer 120 to the electro-conductive component 130, so that the color filter layer 120 may be suppressed in adsorption of foreign matters. The electro-conductive component 130, as viewed in the direction normal to the substrate 100, does not overlap the imaging region 102. Energy of light to be incident on the imaging region 102 may therefore be suppressed from decreasing. Since the electro-conductive component 130 is projected out from the surface of the color filter layer 120, so that foreign matters may more readily be attracted by the electro-conductive component 130, but less likely to be attracted by the color filter layer 120.

The electro-conductive components 130, formed to have the columnar shape, may be more likely to induce corona discharge between themselves and foreign matters. Therefore, amount of electric charge on the foreign matters may more readily be reduced, and thereby the color filter layer 120 may be suppressed in adsorption of the foreign matters in a more efficient manner.

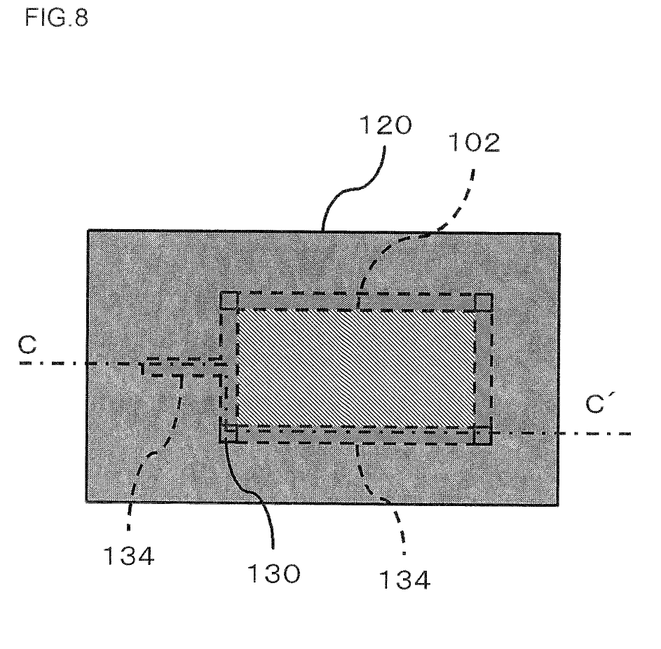

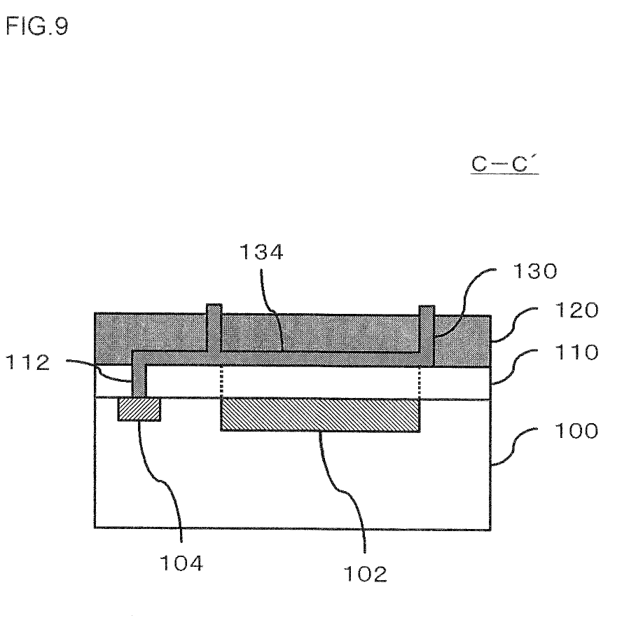

FIG. 8 is a plan view of a solid-state imager according to a fourth embodiment, and FIG. 9 is a sectional view taken along line C-C′ in FIG. 8. The solid-state imager is configured similarly to the solid-state imager according to the third embodiment, except that the impurity-diffused region 104 is formed in the substrate 100, that the contact 112 is formed in the insulating layer 110, and that the electro-conductive pattern 134 is formed over the insulating layer 110.

The contact 112 is positioned on the impurity-diffused region 104. The electro-conductive pattern 134 is formed so as to surround the imaging region 102, and so as to connect the plurality of electro-conductive components 130 with each other. The electro-conductive pattern 134 is covered with the color filter layer 120. The electro-conductive pattern 134 is connected through the contact 112 to the impurity-diffused region 104.

The solid-state imager of this embodiment may be manufactured as follows. First, a plurality of light receiving elements are formed in the imaging region 102 in the substrate 100. The impurity-diffused region 104 is formed in the substrate 100. The insulating layer 110 is then formed over the substrate 100. Next, the insulating layer 110 is selectively removed, to thereby form a contact hole fallen on the impurity-diffused region 104. An electro-conductive film, such as an aluminum film or polysilicon film, is formed in the contact hole and over the insulating layer 110.

Next, a first mask pattern is formed over the electro-conductive film. The first mask pattern covers the electro-conductive film specifically in the portions thereof which will be given later as the electro-conductive components 130. The elector-conductive film is then etched about halfway, using the first mask pattern as a mask. The first mask pattern is then removed.

Next, a second mask pattern is formed on the electro-conductive film. The second mask pattern covers the electro-conductive film specifically in the portions thereof which will be given later as the electro-conductive components 130 and the electro-conductive pattern 134. The electro-conductive film is then etched, using the second mask pattern as a mask. The contact 112, the electro-conductive components 130, and the electro-conductive pattern 134 are formed in this way. The processes thereafter are similar to those in the first embodiment.

Effects similar to those in the third embodiment may be obtained also by this embodiment. The electro-conductive components 130 are connected through the electro-conductive pattern 134 and through the contact 112, to the impurity-diffused region 104 in the substrate 100. By virtue of this configuration, static electricity transmitted to the electro-conductive components 130 may be discharged from the impurity-diffused region 104 to the substrate 100, rather than accumulated in the electro-conductive components 130. The color filter layer 120 may therefore be suppressed in adsorption of foreign matters in a more reliable manner.

The embodiments of the present invention have been described referring to the attached drawings, merely as examples of the present invention, while allowing adoption of various configurations other than those described in the above. For example, the solid-state imager configured as a monochromatic imager has no color filter layer 120, and may use the cover layer, which covers the imaging region 102, as a substitute of the color filter layer 120.

It is apparent that the present invention is not limited to the above embodiment, and that may be modified and changed without departing from the scope and spirit of the invention.

What is claimed is:

1. A solid-state imager, comprising:
a substrate;
an imaging region provided to said substrate, and including a plurality of light receiving elements;
a cover layer formed over and around said imaging region; and
an electro-conductive component exposed from said cover layer, and positioned around said imaging region but without overlapping said imaging region, when viewed in the direction normal to said substrate.

2. The solid-state imager as claimed in claim 1,
further comprising a connection component connecting said electro-conductive component to said substrate.

3. The solid-state imager as claimed in claim 1,
wherein said electro-conductive component surrounds a region above said imaging region.

4. The solid-state imager as claimed in claim 1,
further comprising a voltage application unit applying voltage to said electro-conductive component.

5. The solid-state imager as claimed in claim 1,
wherein said electro-conductive component projects out from said cover layer.

6. The solid-state imager as claimed in claim 1,
including a plurality of said electro-conductive components provided along the circumference of said imaging region, while being spaced from each other.

7. The solid-state imager as claimed in claim 1,
wherein said cover layer is a color filter.

8. A method of manufacturing a solid-state imager, comprising:
forming a plurality of light receiving elements to a substrate;
forming an electro-conductive component over and around said plurality of light receiving elements, but without overlapping said plurality of light receiving elements; and
forming a cover layer over said plurality of light receiving element, so as to allow said electro-conductive component to expose out from said cover layer.
